(19) United States
(12) Patent Application Publication
(10) Pub. No.: US 2024/0101785 A1
(43) Pub. Date: Mar. 28, 2024

(54) Chitosan Graphene Composite for the Treatment of Harmful Algal Blooms and Toxins

(71) Applicant: United States of America as Represented by The Secretary of The Army, Alexandria, VA (US)

(72) Inventors: Luke A Gurtowski, Clinton, MS (US); Christopher S Griggs, Vicksburg, MS (US); Sarah Grace Zetterholm, Clinton, MS (US); Jose A Mattei-Sosa, Vicksburg, MS (US)

(21) Appl. No.: 17/953,326

(22) Filed: Sep. 27, 2022

(51) Int. Cl. C08K 3/04; C02F 1/50; C08J 5/18; C08L 5/08

(52) U.S. Cl. CPC C08K 3/042; C02F 1/50; C08J 5/18; C08L 5/08; C02F 2303/04; C08J 2305/08

(57) ABSTRACT

A chitosan-graphene (CSG) composite material and methods of making the composite material are provided. The CSG composite material is useful for removing microorganisms such as cyanobacteria and blue-green algae from water contaminated with a harmful algal bloom (HAB). The CSG composite material can also remove algal toxins such as microcystins from HAB contaminated water.

### GOVERNMENT INTEREST

The subject matter of this disclosure was made with support from the United States Army Corps of Engineers—Engineer Research and Development Center, Environmental Laboratory. The Government of the United States of America has certain rights in this invention.

### TECHNICAL FIELD

The present disclosure relates to a chitosan graphene composite material and its application for treating harmful algal blooms and toxins in contaminated water. The disclosure also relates to methods of manufacturing the composite material.

### BACKGROUND

Harmful algal blooms (HABs) occur when algal species in fresh, brackish, or salt water rapidly grow out of control. HABs often occur as a consequence of introducing excess inorganic substances such as nitrogen and phosphorus into a body of water, leading to the overgrowth of blue-green algal species. Another cause of HABs comes from nutrient swelling during extreme weather events or from water stagnation during droughts. Warmer water temperatures, especially above 25° C., also contribute to rapid cyanobacteria growth and HAB formation.

HABs can adversely impact water chemistry, degrade drinking water supplies, and impact aquatic life through variation in dissolved oxygen content. The public health threat, effects on the fishing industry, and loss of tourism revenue costs billions of dollars every year. As a part of the U.S. Army Corp of Engineers (USACE) mission to provide management and security to the freshwater resources of the United States, the Engineer Research and Development Center (ERDC) has increased stakes in developing technologies for prevention and mitigation of HABs. These freshwater HABs can adversely impact wildlife, drinking water supplies, and dissolved oxygen content. While most algal species are not harmful to human health or the environment, HABs are usually caused by blue-green algae made up of different types of cyanobacteria that can produce toxins. FIG. 1 shows a HAB outbreak that occurred in Lake Okeechobee, Florida, November 2016.

Biopolymer-graphene-based composites have shown promise for a variety of water treatment applications (Abolhassani et al., 2017; Han et al., 2011). Chitin is a biodegradable biopolymer found in the shells of crustaceans and mollusks and is the second most abundant biopolymer found in nature. Further sources of chitin are fungi, including Basidiomycetes, Ascomycetes, and Phycomycetes, where it is a component of cell walls and structural membranes of mycelia, stalks, and spores. Chitosan (CS) is a linear polysaccharide of β-1,4-poly-D-glucosamine that is a fully or partially N-deacetylated derivative of chitin. CS is produced from chitin by an alkaline deacetylation process with aqueous sodium hydroxide at elevated temperatures or by enzymatic treatment with a chitin deacetylase. CS is a positively charged, biodegradable, antimicrobial, low-cost, and low toxicity biopolymer. These properties make it a suitable polymer backbone for composites used in water treatment. The chemical structures of chitin and chitosan are shown in FIG. 2.

Graphene (G) is a 2D honeycomb network of sp² hybridized carbon. The it bonds in graphene form an extended conjugated network that produces improved mechanical, thermal, and electrical properties that can be used for a variety of applications (Allen et al., 2010). Graphene has been produced using a variety of methods such as mechanical exfoliation, chemical methods, bottom-up synthesis, and flash Joule processes. Pristine graphene is a single layer of graphite, though most commercially available graphene is closer to 10 layers of carbon. This leads to a variety of graphene “grades” from commercial suppliers that have varying particle sizes and surface area.

Graphene oxide (GO) is a chemically modified graphene that contains graphene sheets surrounded by oxygen groups such as hydroxyl, carbonyl, and epoxide groups, which disrupt the carbon backbone. GO is commonly produced from graphite using Hummer's method and can be used as a chemical intermediate to producing graphene. The chemical structures of graphene and graphene oxide are shown in FIG. 3.

GO has been previously used with polymer matrices such as chitosan for use in tissue engineering, sensor applications, and drug delivery (Han et al., 2011; Yang et al., 2010). In addition, it has been used in water treatment as adsorbents for metal ions and dyes as well as pressure-driven membranes (Abolhassani et al. 2017). Chitosan-graphene oxide membranes have also been applied in water filtration membranes (U.S. Pat. Nos. 11,235,291; 11,135,555). However, the cost of commercially available graphene oxide is orders of magnitude more than commercially available graphene.

There is a need for cost-effective composite materials that include a biopolymer template that supplies graphene surfaces suitable for environmental deployment. It is desirable to provide a chitosan-graphene composite material having benefits including low cost, processability, and scalability.

Various genera of cyanobacteria produce microcystins (MCs), a class of cyclic heptapeptides with over 100 different congeners that are an important driver of environmental concern. One of the most studied microcystins is MC-LR, which contains the amino acids leucine and arginine (FIG. 4). MC-LR toxicity results from the formation of an irreversible bond between the toxin and protein phosphatases causing liver damage which can lead to death. Due to the stable molecular structure of MC-LR, the toxin can be released during cell lysis and persist in water for more than 90-120 days as a secondary hazard post bloom. The dangers from the acute toxicity of MC demonstrate the critical need for improved water treatment methods for management of HABs and subsequent toxin removal.

Conventional water treatment media include adsorption-based carbons such as granulated activated carbon (GAC) and powdered activated carbon (PAC). However, removal efficiency and capacity of MC-LR by these thermally produced carbons is dictated by the resulting porosity and surface area. In addition, the performance of activated carbon (AC) is greatly influenced by natural organic matter and other competing contaminants in environmental matrices that can reduce removal efficiency of cyanotoxins (Chen et al., 2021). Alternative carbon media such as GO has shown potential for high-capacity removal of MC-LR that exceeds that of AC, however the performance is pH dependent, achieving maximum removal at pH of <5, which is lower than would be found in natural sources. In addition, the current cost of commercially available GO is orders of magnitude more than other carbon media such as biochar and graphene, making it cost prohibitive for large scale applications.

There exists a need for alternative media to deliver graphene surface functionality to the treatment of HABs and associated toxins in large scale water treatment. Chitosan's low toxicity and biocompatibility make it an interesting polymer substrate for graphene composites useful in water treatment and large-scale broadcast in receiving waters.

### SUMMARY

One aspect of the present disclosure relates to a chitosan-graphene (CSG) composite material. In various embodiments, the CSG composite material includes a chitosan polymer substrate and graphene. Various embodiments of the CSG composite have graphene surface functionality. In various embodiments, the CSG composite material is capable of removing microorganisms and associated toxins from a fluid environment, such as water. Embodiments of the CSG composite material have various sizes and configurations.

Another aspect of the present disclosure relates to methods of making a CSG composite material. The method includes providing a quantity of graphene, providing a quantity of chitosan, combining the chitosan and the graphene to create a chitosan-graphene solution, casting the chitosan-graphene solution to a desired structure, and curing the chitosan-graphene solution.

Another aspect of the present disclosure provides a CSG composite material capable of removing cyanotoxins and microcystins, such as MC-LR, from water. Embodiments of the CSG composite material provide π-π interactions or pi-stacking between the graphene and aromatic molecules of MC.

A further aspect of the present disclosure relates to methods of removing microorganisms from water. In various embodiments, the method includes removing microorganisms, such as algae and cyanobacteria, from contaminated water by bringing the water into contact with embodiments of the CSG composite material described herein.

Another aspect of the present disclosure relates to methods of removing algal toxins, such as cyanotoxins and microcystins, from water. In various embodiments, the method includes removing microcystins, such as MC-LR, from contaminated water by bringing the water into contact with embodiments of the CSG composite material described herein.

Other features and advantages of the present disclosure will be apparent from the following description of the drawings, detailed description, and examples, which should not be construed as limiting the disclosure to the examples and embodiments shown and described.

### BRIEF DESCRIPTION OF THE DRAWINGS

FIG. 1 is a photograph showing a HAB outbreak in Lake Okeechobee, Florida, November 2016.

FIG. 2 is a diagram showing the chemical structures of chitin and chitosan. Chitosan can be produced by deacetylation of chitin.

FIG. 3 is a diagram showing the chemical structures of graphene and graphene oxide.

FIG. 4 is a diagram showing the chemical structure of microcystin-LR and microcystin-RR. Microcystins primarily differ in the two amino acids indicated as X and Y.

FIG. 5A-5C are Scanning Electron microscopy (SEM) surface images of CSG composite materials according to an illustrative embodiment disclosed herein. FIG. 5A: CSG C300 (10 μm); FIG. 5B: CSG C500 (10 μm); FIG. 5C CSG C750 (10 μm).

FIG. 6A-6C are SEM cross sectional and surface images of CSG composite materials according to an illustrative embodiment disclosed herein. FIG. 6A: CSG C300 (20 μm); FIG. 6B: CSG C500 (20 μm); FIG. 6C CSG C750 (20 μm).

FIG. 7A-7C are SEM cross sectional images of CSG composite materials according to an illustrative embodiment disclosed herein. FIG. 7A: CSG C300 (5 μm); FIG. 7B: CSG C500 (5 μm); FIG. 7C CSG C750 (5 μm).

FIGS. 8A and 8B are X-ray photoelectron spectroscopy (XPS) C1s spectra of C750 graphene (FIG. 8A) and a CSG 750 graphene-chitosan composite material (FIG. 8B) according to an illustrative embodiment disclosed herein.

FIG. 9A-9B are Powder X-ray Diffraction (PXRD) analysis results of pure chitosan (CS), graphene oxide (GO), and C300, C500, and C750 graphene (G) used as starting materials to make illustrative embodiments of the composite materials (FIG. 9A), and PXRD analysis results of chitosan graphene oxide (CSGO) and chitosan graphene (CSG) composite materials (FIG. 9B) according to illustrative embodiments disclosed herein.

FIG. 10A-10C are bar graphs showing percent removal of Anabaena sp. (FIG. 10A), Synechocystis sp. (FIG. 10B), and Microcystis aeruginosa (FIG. 10C) after 24 hr incubation with CSGO and CSG composite materials, and CS, GO, and G powdered materials, according to illustrative embodiments disclosed herein.

FIG. 11 is a bar graph showing percent removal of microcystin from M. aeruginosa after 24 hr incubation with CSGO and CSG composite materials, and CS, GO, and G powdered materials, according to illustrative embodiments disclosed herein.

FIG. 12 is a diagram showing π-π interactions or pi-stacking between graphene and the aromatic molecules of microcystin.

FIG. 13 is a bar graph showing the percent removal of MC-LR over time with GO and G powdered materials, and CSGO and CSG composite materials, according to illustrative embodiments disclosed herein.

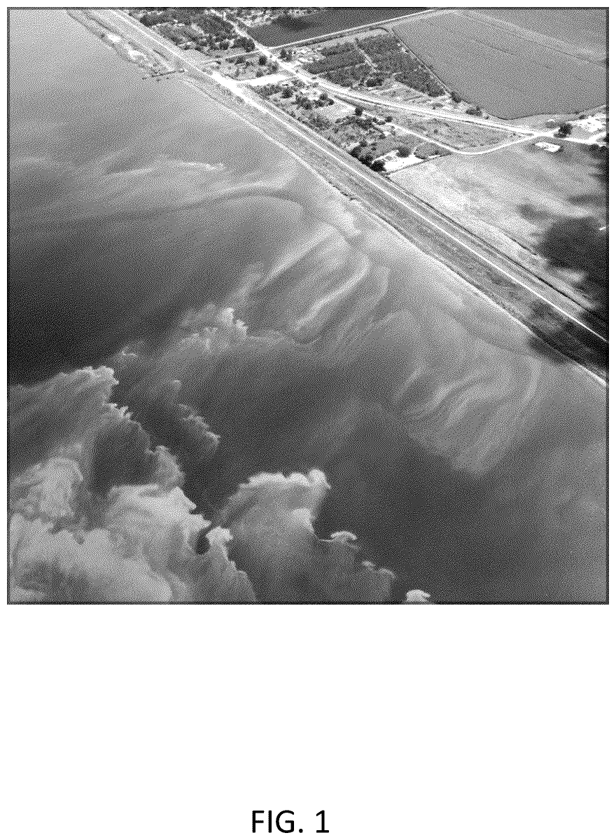

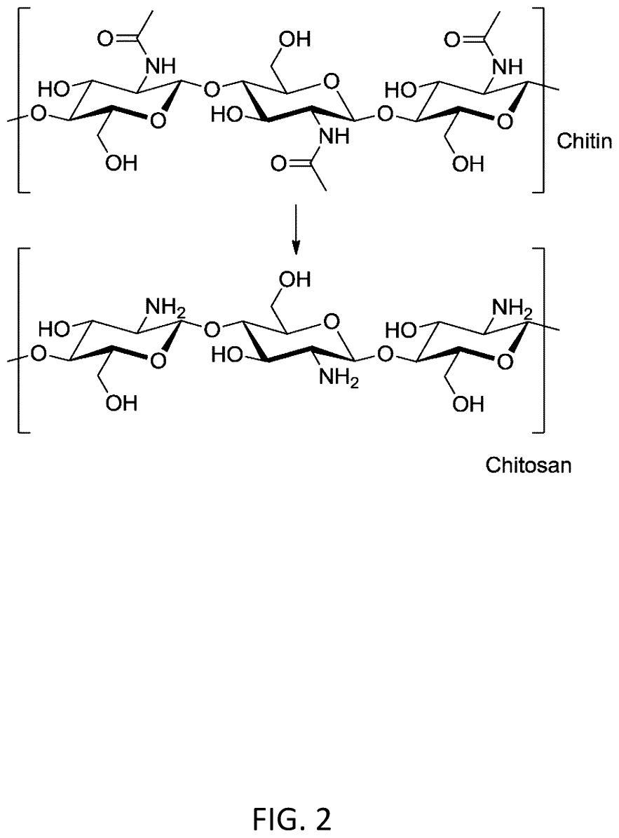

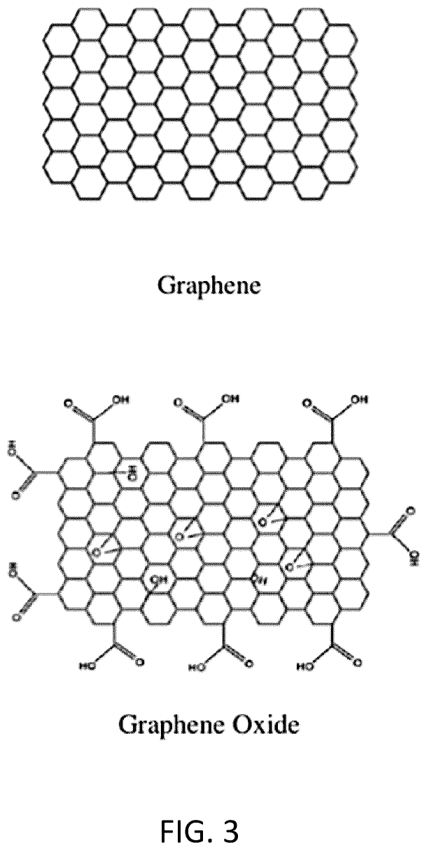

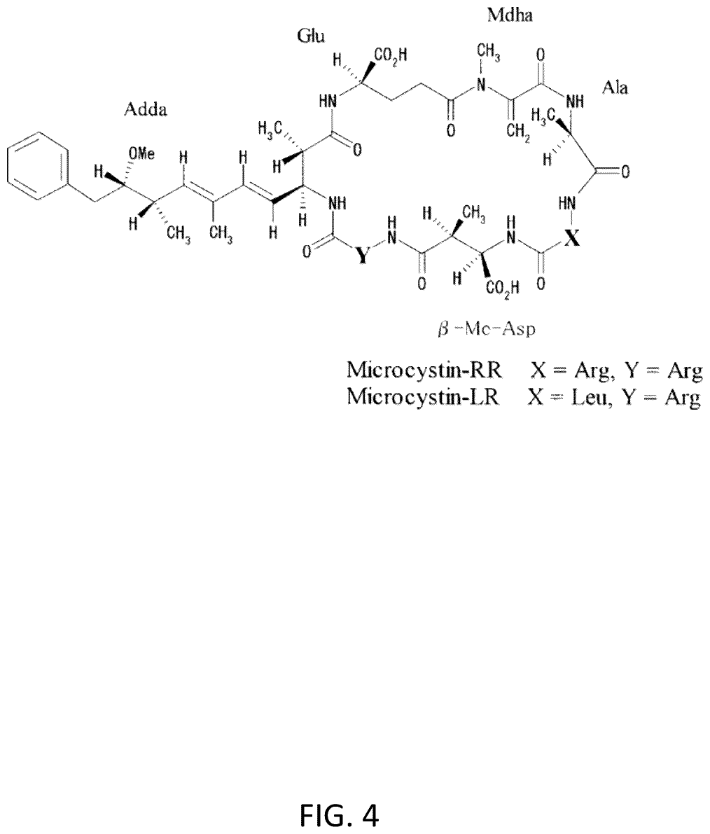

### DETAILED DESCRIPTION

While the present disclosure will be described in conjunction with specific embodiments, the disclosure can be applied to a wide variety of applications, and the description herein is intended to cover alternatives, modifications, and equivalents within the spirit and scope of the disclosure and the claims. The description in the present disclosure should not be viewed as limiting or as setting forth the only embodiments of the disclosure, as the disclosure encompasses other embodiments not specifically recited herein. The present disclosure is directed toward all novel and non-obvious features and aspects of the various disclosed embodiments. Any theories of operation are to facilitate explanation, but the disclosed methods and devices are not limited to such theories of operation.

Various embodiments of the present disclosure relate to a chitosan-graphene (CSG) composite material, methods of making the CSG composite material, methods of removing microorganisms such as algae and cyanobacteria, and removing algal toxins, such as microcystin and other cyanotoxins, from contaminated water using the CSG composite material.

According to various embodiments, the CSG composite material contains graphene and chitosan. The term “graphene” as used herein refers to, for example, graphene nanoplatelets, pristine graphene, crumpled graphene, functionalized graphene, chemically converted graphene, chemically modified graphene, and combinations thereof. Graphene also includes graphene produced from exfoliated graphite or reduced graphite oxide, which may require further processing to obtain graphene.

Commercial graphene is often classified according to particle size and surface area of the aggregates of nanoscale platelets. For example, XG Sciences provides four grades of graphene nanoparticles, including Grade R, Grade H, Grade M, and Grade C, where each grade contains particles with a similar average thickness and surface area, as shown in Table 1.

TABLE 1

| Grade | Particle Size (μm) | Surface Area (m²/g) |
|---|---|---|
| R | 7, 10, 25 | 30-60 |
| H | 5, 10, 15 | 50-80 |
| M | 5, 10, 15 | 120-150 |
| C | 2 | 300, 500, 750 |

The term “chitosan” as used herein not only includes the natural polysaccharide β-1,4-poly-D-glucosamine obtained by deacetylation of chitin or by direct isolation from fungi but also includes synthetically produced β-1,4-poly-D-glucosamines and derivatives thereof of equivalent structure to chitosan. Chitosan includes chitosan, chitosan salts, chitosan derivatives, and combinations thereof.

Chitosan is a non-toxic, biocompatible, and biodegradable polymer. The molecular weight (MW) of chitosan has been shown to be a factor in chitosan properties such as crystallinity, degradation, tensile strengths, and moisture content. The MW of chitosan can depend on the initial source material (shrimp, crab, fungi, etc.). Various embodiments of the CSG composite material contain chitosan having a molecular weight in a range of about 10-2,000 kDa, about 50-1,500 kDa, about 100-1,000 kDa, about 50-100 kDa, about 150-500 kDa, about 600-1,000 kDa, or about 190-310 kDa. Commercial chitosan is often provided in various molecular weights, such as low molecular weight (˜50-190 kDa), medium molecular weight (˜190-310 kDa), and high molecular weight (˜310-375 kDa).

In various embodiments, the chitosan has been derived from chitin and at least 50% of the N-acetyl groups have been removed (i.e., at least 50% deacetylation) from the chitin. Chitosan degree of deacetylation (DDA) has been shown to be a factor that determines several physiochemical and biological properties of chitosan such as crystallinity, hydrophilicity, and degradation. Higher DDA chitosan films have been shown to have a greater crystallinity, a higher elastic modulus and tensile strength, and a lower swelling index than those with lower DDA. In various embodiments of the CSG composite material, the chitosan has a DDA in a range of about 60-100%, about 65-80%, about 70-90%, about 80-95%, about 70-85%, or about 75%. In some embodiments, the DDA is greater than 70%, greater than 75%, greater than 80%, or greater than 90%. In some embodiments, the chitosan has a DDA of about 75% to about 85%.

In various embodiments of the CSG composite material, the graphene includes nanoplatelets having a particle surface area in a range of about 20-2000 m²/g. In various embodiments, the nanoplatelets have a particle surface area in a range of about 30-60 m²/g, about 50-80 m²/g, about 120-150 m²/g, about 100-1000 m²/g, about 30-750 m²/g, about 300-750 m²/g, or about 500-750 m²/g, or a particle surface area of about 300 m²/g, 500 m²/g, or 750 m²/g. In some embodiments, the nanoplatelets have a particle surface area larger than 300 m²/g, larger than 500 m²/g, or larger than 750 m²/g. Some embodiments have a combination of nanoplatelet sizes, such as nanoplatelets of about 500 m²/g and about 750 m²/g.

In various embodiments of the CSG composite material, the graphene includes nanoplatelets having a particle size in a range of about 0.2-100 μm. In various embodiments, the nanoplatelets have a particle size in a range of about 0.5-50 μm, about 7-25 μm, about 5-15 μm, or about 1-5 μm, or a particle size of about 2 μm. In some embodiments, the nanoplatelets have a particle size of less than 5 μm or less than 2 μm. In some embodiments, the nanoplatelets have a combination of particle sizes, such as nanoplatelets of about 2 μm and 5 μm.

Various embodiments of the CSG composite material contain graphene and chitosan in a range of amounts. Embodiments of the CSG composite contain graphene in a range of 1%-99% by weight, or about 5%, 10%, 15%, 20%, 25%, 30%, 40%, 50%, 60%, 70%, 75%, 80%, 85%, 90%, or 95% by weight of graphene. Embodiments of the CSG composite material contain chitosan in a range of 1%-99% by weight, or about 5%, 10%, 15%, 20%, 25%, 30%, 40%, 50%, 60%, 70%, 75%, 80%, 85%, 90%, or 95% by weight of chitosan. Some embodiments of the CSG composite material contain graphene in a range of about 10-25%, about 15-18%, or about 16-17% by weight, and contain chitosan in a range of about 75-90%, about 82-85%, or about 83-84%.

Various embodiments of the CSG composite material contain graphene and chitosan, and have a ratio of chitosan to graphene in a range of about 20:1 to 1:1 w/w, or about 15:1 w/w, 10:1 w/w, 8:1 w/w, 5:1 w/w, 4:1 w/w, or 2:1 w/w. Some embodiments of the CSG composite material have a ratio of chitosan to graphene in a range of about 5:1 to about 4:1 w/w.

Various embodiments of the CSG composite material have an area density in a range of about 0.010 mg/mm² to about 0.20 mg/mm². Various embodiments have an area density of about 0.020-0.15 mg/mm², about 0.030-0.10 mg/mm², about 0.040-0.080 mg/mm², or about 0.045 mg/mm² to 0.072 mg/mm².

In addition to graphene and chitosan, various embodiments of the CSG composite material further include one or more additional components, such as graphene oxide (GO). In some embodiments, the CSG composite material includes about 0.1%-10% by weight of GO, or about 0.2%, 0.5%, 1%, 2%, or 5% GO by weight of GO. In some embodiments, the CSG composite material includes at least 0.2% by weight of GO, and in some embodiments no more than 5% by weight of GO.

In various non-limiting embodiments, the CSG composite material is in the form of a sheet, a film, or a membrane. The term “sheet” as used herein refers to an article having a generally planar form and that is thin in comparison to its length and breadth. The term “film” as used herein refers to a thin skin or membrane or sheet of material used to cover at least partially a portion of a surface. The term “membrane” as used herein refers to a porous structure and may be capable of separating molecules, particles, or substances that pass through it. The “pores” of the membrane allow fluid communication between different sides of the structure and through which solvent molecules may pass but only some solute particles and/or substances may pass as determined by size, charge, solubility, chemical properties, etc. In some embodiments, the CSG composite material is a flat sheet.

The thickness of the CSG composite material varies depending on its applications, and various embodiments of the composite material have a thickness in a range of about 1 μm to about 1000 μm, or in a range of about 2 μm-500 μm, 5 μm-200 μm, 10 μm-100 μm, or about 15 μm 75 μm.

According to various embodiments, the CSG composite material is a scalable CSG composite material. In some embodiments, the CSG composite material is a flat sheet having a surface area of a side of the sheet of about 100 m², or about 50 m², 25 m², 10 m², 5 m², 2 m², or 1 m². Some embodiments of the CSG composite material have a surface area greater than 100 m².

Various embodiments of the present disclosure are directed to methods of making a CSG composite material. According to various embodiments, the method includes providing a quantity of graphene, providing a quantity of chitosan, combining and/or mixing the chitosan with the graphene to create a chitosan-graphene solution, casting the chitosan-graphene solution to a desired structure, and curing the chitosan-graphene solution.

In various embodiments of the method, the graphene includes nanoplatelets having a particle surface area in a range of about 20-2000 m²/g. In various embodiments, the nanoplatelets have a particle surface area in a range of about 30-60 m²/g, about 50-80 m²/g, about 120-150 m²/g, about 100-1000 m²/g, about 30-750 m²/g, about 300-750 m²/g, or about 500-750 m²/g, or a particle surface area of about 300 m²/g, 500 m²/g, or 750 m²/g. In some embodiments, the nanoplatelets have a particle surface area larger than 300 m²/g, larger than 500 m²/g, or larger than 750 m²/g. Some embodiments have a combination of nanoplatelet sizes, such as nanoplatelets of about 500 m²/g and about 750 m²/g.

In various embodiments of the method, the graphene includes nanoplatelets having a particle size in a range of about 0.2-100 μm. In various embodiments, the nanoplatelets have a particle size in a range of about 0.5-50 μm, about 7-25 μm, about 5-15 μm, or about 1-5 μm, or a particle size of about 2 μm. In some embodiments, the nanoplatelets have a particle size of less than 5 μm or less than 2 μm. In some embodiments, the nanoplatelets have a combination of particle sizes, such as nanoplatelets of about 2 μm and 5 μm.

In various embodiments of the method, the chitosan has a molecular weight in a range of about 10-2,000 kDa, about 50-1,500 kDa, about 100-1,000 kDa, about 50-100 kDa, about 150-500 kDa, about 600-1,000 kDa, or about 190-310 kDa. In various embodiments, the chitosan has a DDA in a range of about 60-100%, about 65-80%, about 70-90%, about 80-95%, about 70-85%, or about 75%. In some embodiments, the DDA is greater than 70%, greater than 80%, or greater than 90%. In some embodiments, the chitosan has a DDA of about 75% to about 85%.

Various embodiments of the method provide graphene and chitosan in a range of amounts. Embodiments of the method provide graphene in a range of 1%-99% by weight of the CSG composite material, or about 5%, 10%, 15%, 20%, 25%, 30%, 40%, 50%, 60%, 70%, 75%, 80%, 85%, 90%, or 95% by weight of the CSG composite material, and provide chitosan in a range of 1%-99% by weight of the CSG composite material, or about 5%, 10%, 15%, 20%, 25%, 30%, 40%, 50%, 60%, 70%, 75%, 80%, 85%, 90%, or 95% by weight of the CSG composite material. In some embodiments, the graphene and chitosan are combined and/or mixed in an amount to produce the CSG composite having graphene in a range of 10-25%, 15-18%, or about 16-17% by weight, and chitosan in a range of 75-90%, 82-85%, or about 83-84% by weight. In some embodiments, the graphene and chitosan are combined and/or mixed in an amount to produce the CSG composite having a ratio of chitosan to graphene in a range of about 20:1 to 1:1 w/w, or about 15:1 w/w, 10:1 w/w, 8:1 w/w, 5:1 w/w, 4:1 w/w, or 2:1 w/w.

In some embodiments, the method further includes providing a quantity of one or more additional component and combining and/or mixing the additional component with the chitosan and graphene. In some embodiments, the method further includes providing a quantity of graphene oxide and combining and/or mixing the graphene oxide with the chitosan and graphene. In some embodiments, the method provides graphene oxide in a range of about 0.1%-10% by weight, or about 0.2%, 0.5%, 1%, 2%, or 5% by weight of the CSG composite oxide. In some embodiments, the CSG composite material includes at least 0.2% by weight of GO, and in some embodiments no more than 5% by weight of GO. In some embodiments, the provided graphene comprises a percentage of GO, such as about 0.1%-10% GO by weight of the graphene.

In some embodiments of the method, the graphene is provided in an aqueous solution, such as water. In some embodiments, the graphene is sonicated in the aqueous solution to create a graphene dispersion. Embodiments of the method sonicate the graphene with ultrasonic frequencies (i.e., >20 kHz) and are conducted using an ultrasonic bath or an ultrasonic probe or a sonicator.

According to various embodiments of the method, the chitosan and graphene are combined and/or mixed in an acidic solution. In various embodiments, the acidic solution contains an organic acid, such as acetic acid, malic acid, succinic acid, glycolic acid, oxalic acid, adipic acid, citric acid, formic acid, carboxylic acid, sulfonic acid, muriatic acid, tannic acid, or a combination thereof. In some embodiments, the acidic solution contains acetic acid. In various embodiments, the graphene and/or the chitosan is provided in an aqueous solution, such as water, and in other embodiments, the graphene and/or the chitosan is provided in a dry form, such as a powder. In various embodiments, the organic acid and the chitosan are added to the graphene, or the graphene is added to the organic acid and the chitosan.

In some embodiments of the method, the chitosan is positively charged or “protonated.” In embodiments, a quantity of chitosan is mixed with or treated with an acid to create positively charged (protonated) chitosan. In embodiments, the acid is an organic acid, such as acetic acid, malic acid, succinic acid, glycolic acid, oxalic acid, adipic acid, citric acid, formic acid, carboxylic acid, sulfonic acid, muriatic acid, tannic acid, or a combination thereof. Embodiments of protonated chitosan have increased water solubility compared to unprotonated chitosan.

According to various embodiments of the method, the combining and/or mixing includes stirring the chitosan-graphene solution to ensure complete mixing of the components of the solution. In some embodiments, the chitosan and graphene are mixed to form a homogenous mixture. In various embodiments, the chitosan and graphene are mixed for at least one hour, at least 6 hours, at least 12 hours, at least 18 hours, at least 24 hours, at least 48 hours, or for more than 48 hours. In various embodiments, the mixing is carried out at a temperature in a range of about −20° C.-100° C., 0° C.-80° C., 10° C.-50° C., 20° C.-30° C., at ambient temperature, at room temperature, or at about 20° C.

According to various embodiments of the method, the chitosan-graphene solution is cast to fabricate a desired structure. Non-limiting embodiments of the desired structure include a sheet, a film, and a membrane. In embodiments, the desired structures are fabricated using any suitable method, for example, drop casting, spray coating, dip coating, spin coating, bar coating, or a combination thereof.

In some embodiments, the chitosan-graphene solution is cast into a mold. According to various embodiments, the chitosan-graphene solution is cast onto a suitable substrate, including, but not limited to, polypropylene (PP), polytetrafluoroethylene, polyether ether ketone (PEEK), polyoxymethylene, chlorinated polyvinyl chloride, polyethylene, polysulfone, polyurethane, polyvinyl fluoride, polyvinylidene fluoride (PVDF), or a combination thereof. In embodiments, the mold is a smooth, non-absorbent sheet with edges to retain the solution.

In various embodiments, the chitosan-graphene solution is cast to create a total surface area in a range of 10-1000 cm² per 100 mL of solution. In some embodiments, the chitosan-graphene solution is cast to create a total surface area of about 50-500 cm², 100-300 cm², or 180-220 cm² per 100 mL of solution, or about 200 cm² per 100 mL of solution.

According to various embodiments of the method, curing the chitosan-graphene solution includes evaporating the solution. Embodiments include evaporating the chitosan-graphene solution under suitable conditions of temperature, pressure, and time. In various embodiments, the solution is evaporated at a temperature in a range of −20° C.-100° C., 0° C.-80° C., 10° C.-50° C., 20° C.-30° C., at ambient temperature, or at about 20° C. In some embodiments, the chitosan-graphene solution is evaporated at room temperature. In various embodiments, evaporating the solution occurs for at least 6 hours, at least 12 hours, at least 18 hours, at least 24 hours, or at least 48 hours. In some embodiments, the solution is evaporated under vacuum or reduced air pressure, and in some embodiments the solution is evaporated under normal or ambient atmospheric pressure. In various embodiments, convective air flow is employed to accelerate the evaporation process. In some embodiments, heat is used to accelerate the evaporation process.

Embodiments of the method include casting the chitosan-graphene solution onto a surface to create a desired structure, such as a flat sheet, film, or membrane, and evaporating the solution to create the desired structure having a target thickness.

Various embodiments of the method are cost effective and provide an efficient way of producing a CSG composite material. According to various embodiments, the method of making the CSG composite material is scalable. The method is carried out using aqueous-based solvents which are easily available and easy to handle. Embodiments of the method are safe and environmentally friendly because no organic solvents are required, and the method is carried out at room or ambient temperatures. Another advantage in accordance with various embodiments of the method includes increased simplicity of operation.

Various embodiments of the present disclosure relate to methods of removing microorganisms from water by bringing the water into contact with a CSG composite material. In various embodiments, the method incorporates embodiments of the CSG composite material disclosed herein. The method is not limited to removing any type of microorganism, and embodiments of the method are applied to remove microorganisms such as virus, bacteria, archaea, fungus, yeast, mold, algae, protozoa, and parasites. In various embodiments, the microorganism is one or more type of cyanobacteria, blue-green algae, golden algae, phytoplankton, benthic algae, or macroalgae. In some embodiments, the method removes algae and/or cyanobacteria from water contaminated by a HAB. In some embodiments, the microorganism is cyanobacteria, such as one or more of genera Microcystis, Anabaena, Dolichospernum, Synechocystis, Fischerella, Gloeotrichia, Nodularia, Nostoc, Oscillatoria, Planktothrix, Raphidiopsis, Cylindrospermopsis, Aphanizomenon, Umezakia, Lyngbya, Chrysosporum, Cuspidothrix, Cylindrospermum, Phormidium, Tychonema, and Woronichinia.

According to various embodiments of the method, the water includes at least one of fresh water, brackish water, and salt water. In various embodiments, the water is at least one of a stream, a creek, a river, a pond, a reservoir, irrigation water, a source of drinking water, a pool, a lake, a lagoon, a bay, a sea, and an ocean.

Microcystis is a genus of cyanobacteria that can be found in freshwater environments in over 100 countries worldwide. Microcystis colonies are composed of unicellular spherical cells with a diameter typically between 1-9 iim. The cells can aggregate into colonies because of environmental conditions such as water column mixing. Microcystis blooms occur under a combination of environmental factors. Water temperatures above 15° C. favor bloom formation. Microcystis differs from other genera of cyanobacteria in that it is not nitrogen fixing, and therefore needs an external source of nitrogen to survive as it cannot consume nitrogen from the atmosphere. Microcystis is also capable of moving vertically throughout the water column, sinking to deeper waters with higher nitrogen and then floating to the surface to maximize UV exposure. This sinking mechanism also allows algal exposure to phosphorus, which Microcystis can use even at low concentrations. Microcystis is the most common bloom-forming genus and is almost always toxic. Microcystis blooms resemble a greenish, thick, paint-like (sometimes granular) material that accumulates along shores. Scums that dry on the shores of lakes may contain high concentrations of microcystin for several months, allowing toxins to dissolve in the water even when the cells are no longer alive or after a recently collapsed bloom.

Anabaena is a genus of filamentous cyanobacteria with nitrogen fixing abilities. Anabaena, like Microcystis, can move vertically through the water column upwards for access to light and downwards for carbohydrate consumption. Anabaena is favored in high water temperatures above 22° C., with some strains reaching maximum growth at 42° C. Because it is nitrogen fixing, Anabaena can survive in environments with dissolved nitrogen content as long as sufficient light is present. Phosphorus does need to be present in sufficiently high amounts for Anabaena growth to occur. Some strains of Anabaena can produce toxins such as microcystin, anatoxin, or saxitoxins. Species of Anabaena form slimy summer blooms on the surface of eutrophic lakes and reservoirs. Anabaena blooms may develop quickly and resemble green paint. In less eutrophic waters, some species also form colonies, which are large dark dots in water samples and on filters after filtration.

Synechocystis is a genus of unicellular freshwater cyanobacteria. Synechocystis is genetically highly adaptable and has a small cell diameter of approximately 1.5 iim. Synechocystis shows a growth rate maximum at 33° C. and does not need large quantities of nitrogen to survive. Synechocystis displays mixotrophic growth throughout the water column displaying autotrophic energy production in light areas near the surface and heterotrophic consumption tendencies in deeper waters. Phosphorus concentrations make little difference on total biomass growth for this cyanobacterium. Some strains of Synechocystis have shown MC production.

Various embodiments of the present disclosure relate to methods of removing algal toxins from toxin-contaminated water by bringing the water into contact with a CSG composite material. In various embodiments, the method incorporates embodiments of the CSG composite material disclosed herein. Various embodiments of the method remove cyanotoxins, such as one or more of microcystins, cylindrospermopsin, anatoxins, and saxitoxins, from water contaminated by a HAB.

Microcystins are the most widespread cyanobacterial toxins and can bioaccumulate in common aquatic vertebrates and invertebrates such as fish, mussels, and zooplankton. Microcystins primarily affect the liver (hepatotoxin) but can also affect the kidney and reproductive system. There is evidence of an association between liver and colorectal cancers in humans and microcystins exposure, and some evidence that microcystin-LR is a tumor promoter in mechanistic studies. The primary toxic effects of cylindrospermopsin are damage to the liver and kidney. Anatoxins bind to neuronal nicotinic acetylcholine receptors affecting the central nervous system (neurotoxins). There are multiple variants, including anatoxin-a, homoanatoxin-a, and anatoxin-a(s). Saxitoxins are representative of a large toxin family referred to as the Paralytic Shellfish Poisoning (PSP) toxins. When toxigenic marine dinoflagellates are consumed by shellfish, toxins concentrate and are delivered to consumers of the shellfish.

The following examples illustrate various embodiments of the disclosure. One skilled in the art will recognize that the examples set out below are not an exhaustive list of the embodiments of the disclosure.

### EXAMPLES

The CSG composite material and methods of making and using the composite material disclosed herein are further illustrated by the following examples, which are provided for the purpose of demonstration and not limitation.

### Materials

CSG composites were fabricated using medium molecular weight chitosan (CS) (190,000-310,000 g/mol), with 75-85% deacetylation (Sigma Aldrich). The graphene was obtained in three grades, classified according to particle size (2 μm) and surface area of the graphene nanoplatelets (GnPs): C300 (300 m²/g), C500 (500 m²/g), and C750 (750 m²/g) (XG Sciences). CSG composites were made with nanopure water and 99% acetic acid (Sigma Aldrich).

Laboratory monocultures of Microcystis aeruginosa (UTEX LB 2385), Anabaena sp. (UTEX 1448), and Synechocystis sp. (PCC6803) were maintained in Cyanobacteria BG-11 Freshwater Solution (MilliporeSigma), which was diluted to a 1× solution in Milli-Q water. For the kinetic experiments, a MC-LR stock solution of 8 μg/L was prepared from solids (Eurofins Abraxis) using 10% (v/v) methanol in ultrapure water.

### Example 1

### Composite Fabrication

To make CSG composites, 300 mg of C300, C500, or C750 graphene (G) was added to 150 mL of nanopure water. The resulting mixture was sonicated for 1 hour (h) at a frequency of 37 kHz with no temperature control to create a G dispersion. After sonication, 1 mL of acetic acid and 1.5 g CS were added to the dispersion. The resulting mixture was stirred using a mechanical stir bar and stir plate at medium-high speed for 48 h. Once stirring was complete, 50 mL CSG mixture was poured into polypropylene molds to create a total surface area of 97 cm². The mixture was then dried under a hood at ambient temperature until all liquid was evaporated, typically 24-48 h.

### CSG Composite Characterization

Surface and cross-sectional CSG composite morphology was analyzed by Scanning Electron microscopy (SEM) with a Jeol JSM-6000Plus NeoScope in high vacuum mode at 15 kV. Samples were mounted in the desired orientation using carbon tape to secure the composite in place. For cross sectional determination, the edges were exposed using shears, and samples were mounted on edge. All measurements were taken at 90° with respect to the mounting block surface. Images were optimized and captured using the built in NeoScope GUI.

X-ray Photoelectron Spectroscopy (XPS) measurements were taken with a ThermoFisher Scientific ESCALAB™ Xi+ spectrometer equipped with a monochromatic Al X-ray source (1486.6 eV) and a MAGCIS™ Ar⁺/Arn⁺ gas cluster ion sputter gun. All measurements used the standard lens and charge compensation. For survey scans, the pass energy of the analyzer was set to 150 eV with a 1 eV step resolution. The dwell time for survey scans was 50 ms, and each survey was the composite of 2 scans. Binding energies were calibrated with respect to C is at 248.8 eV. Sputtering experiments were performed by rastering an argon ion beam in the cluster mode at 6000 eV and 300 cluster size with an etch time of 300 s. Measurements were taken with an x-ray spot size of 650 inn. All spectra were recorded and processed using THERMO SCIENTIFIC™ Advantage software package v5.9904.

The crystallinity of the powdered starting materials (chitosan, graphene oxide, and GnPs) and the CSG composites was analyzed via powder x-ray diffraction (PXRD) using a Bruker D2 Phaser x-ray diffractometer with Cu Kα radiation (1.54184 Å). XRD data was recorded from 2θ=5-40° with a scanning speed of 2°/min and 0.024° resolution. Generator current (10 mA) and voltage (30 kV), as well as the sample rotation speed of 15°/sec, were consistent for all samples.

### Example 2

### Algal Culture Preparation

Cultures were grown under a 12:12 light-dark cycle at a photosynthetic photon flux density of approximately 140 μmol·m−2s−1 and a set temperature of 21° C. Experimental cultures were inoculated at an optical density of 0.07 measured at 680 nm on a Shimadzu UV-Vis 1800 Spectrophotometer and grown for a period of 7 days (d) to ensure cells are in exponential growth. Once exponential growth was attained, cultures grown to an optical density above 0.13 were diluted in a 1× solution of BG-11 to an optical density of 0.13 at 680 nm.

### Algal Testing Experimental Design

The removal of algae was studied by suspending the materials (CSG, CSGO, CS, GO, and G) in spiked algae water and testing the optical density using UV-VIS at room temperature. The CSG and CSGO composites were uniformly prepared by making equal thickness circular cutouts using a circular die cutter. The mass of these cutouts was determined by weighing on a microbalance. The masses of the powdered CS, G, and GO were chosen from the equivalent mass of a 50 mm diameter CSG and CSGO composite cutout. The various diameters of the CSG and CSGO composite cutouts and the masses of all materials used are shown in Table 2.

Prior to adding any material, 16 mL of the three algae species were each pipetted into separate 20 mL scintillation vials using a FISHERBRAND™ Elite Adjustable-Volume 1-10 mL pipette. Initial UV-VIS density measurements were taken at time zero, before adding any materials. Each material was then added to the algae samples and allowed to mix on an orbital shaker at 80 rpm to simulate the environmental water motion for 24 hours. Samples were taken at time zero before materials were added, 45 minutes, 2 h, 4 h, and 24 h by removing the vials from the shaker, taking 1 mL of sample using a FISHERBRAND™ Elite 1-1000 μL pipette, and placing the vials back on the shaker. For Microcystis aeruginosa, MC-LR data was collected at time zero and at 24 hours. The density of the samples was immediately analyzed using UV-VIS, followed by storage in a −20° C. freezer.

TABLE 2

| CSG/CSGO | CSG/CSGO | CS mass | GO/G mass |
|---|---|---|---|
| diameter (mm) | mass (mg) | (mg) | mg |
| 5 | 9 | | |
| 10 | 18 | | |
| 20 | 36 | | |
| 30 | 54 | | |
| 50 | 90 | 75 | 15 |
| | | 225 | 45 |

Composite diameter and mass of materials exposed to algae. The diameter in column 1 is the size die cutter that was chosen, while the mass in column 2 corresponds to the size cutout from column 1.

### Example 3

### Algal Density and Microcystin Analytical Techniques

Algal suspensions had density measurements taken using a UV-VIS spectrometer at 680 nm (Mehrubeoglu et al., 2013). For each algal solution, a 1 mL sample was placed into polystyrene cuvettes with a 10 mm path length. Samples were blanked against BG-11 in DI water using a split beam Shimadzu UV-1800 spectrophotometer. Single absorbance values were recorded.

To quantify the amount of microcystin (MC-LR) in samples, 1 mL samples were taken at time zero and at 24 h and frozen until analyzed. The sample was added to 0.1 mm silica beads in a Lysing Matrix B tube. Samples were then homogenized on a FASTPREP™ homogenizer (MP Biomedicals) at 4.0 m/s for 1 minute. This procedure was repeated two additional times and samples were placed on ice for a duration of 1 min in between each homogenization step. After homogenization, samples were centrifuged, and the resulting supernatant was retained. An enzyme-linked immuno-sorbent assay (ELISA) was then performed on the samples using the Microcystin/Nodularins-ADDA ELISA Kit (Eurofins Abraxis, Product 520011). The assay was conducted in adherence with the manufacturer's protocol. (EPA Water Treatment Optimization for Cyanotoxins, Version 1.0, 2016).

### MC-LR Kinetic Study

The kinetic study was conducted to determine the time point at which the maximum removal of MC-LR occurred with the use of the graphene and CSG materials. Prior to the experiments, a MC-LR stock solution of 1500 μg/L was prepared using 5% methanol in ultrapure water. The experiments were performed by diluting the MC-LR stock solution to a concentration of 8 μg/L in ultrapure water. For removal, 50 mg of each graphene material, including powdered G and GO, and CSG and CSGO composite cutouts were used. Samples were collected after the MC-LR was exposed to the materials at time 0 (before adding material), 1, 5, 15, 30, 60, 120, 360, and 1440 minutes.

### Example 4

### Material Characterization

The surface morphology and surface roughness for the CSG C300, CSG C500, and CSG C750 composites were visually characterized by SEM to determine any morphological or topographical changes in the surface after adding the GnPs to the CS material. Overall, the morphology and roughness of the CSG composite surface changed as the surface area of graphene increased, indicating a direct correlation in the two properties. Other investigators have shown that the surface morphology for CS films is relatively smooth (Abolhassani et al., 2017).

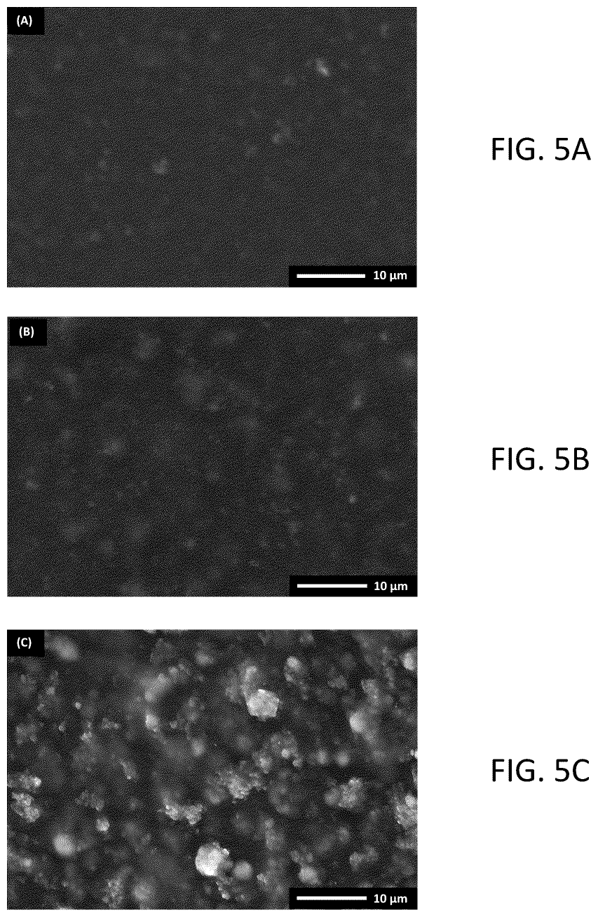

Surface morphology for the composites indicates a chitosan-dominant composite for the lower surface area CSG composites with a trend towards graphene surface functionality with increasing surface area. The CS dominates the surface morphology of the lower surface area C300 composite as a smooth film relatively free of structure (FIG. 5A). With increased surface area, the C500 composite shows increased presence of graphene structure at the same magnification (FIG. 5B). The C750 composite has a much rougher surface morphology than the C300 or C500 composites (FIG. 5C). This image shows some portion of the surface in focus, while other parts of the surface are out of focus, indicating a large height disparity between different points on the surface. The surface morphology of the C750 composite appears to be driven by graphene particles being more pronounced and thus more available for surface interactions.

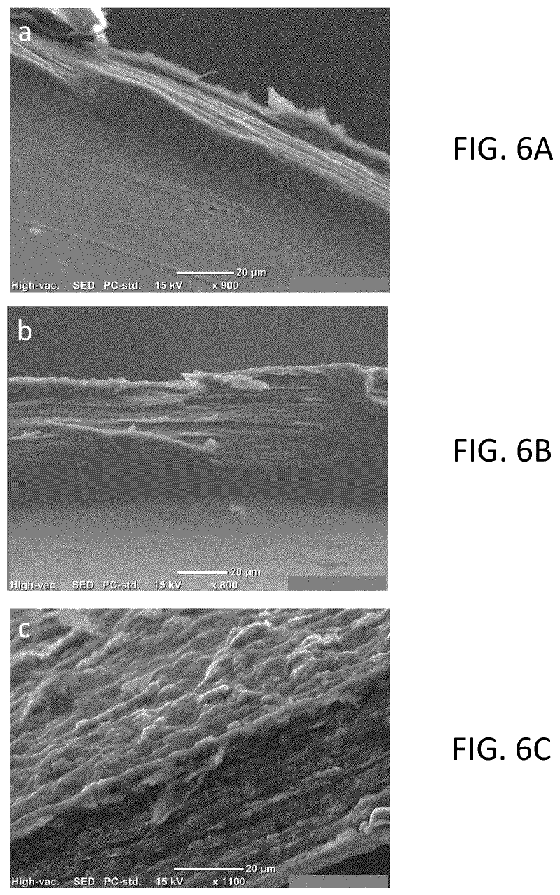

Additional images were taken to further explore the surface and cross-sectional morphology of the CSG composites. These SEM images confirm the flatter surface morphology for C300 (FIG. 6A) and C500 (FIG. 6B) and confirm the surface morphology proposed for C750 as being rough with large height differences (FIG. 6C). Graphene particles are clearly visible at the surface of the C750 composite confirming that graphene is the primary determinant of the surface morphology. The cross-sectional morphology can also be seen in these images. Layering is present in all three composites, with the layers becoming less distinct as the surface area of the graphene increases.

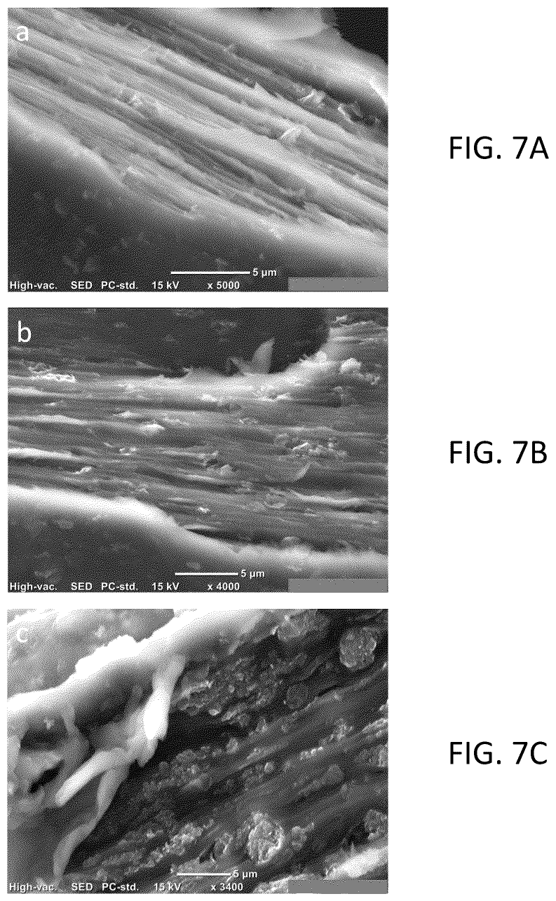

Further images were captured to get a closer view of the cross-sectional layering. The layers for the C300 composite (FIG. 7A) appear to be layers of stacked sheets and are similar to the cross-sectional morphology of CSGO composites discussed in previous studies (Abolhassani et al., 2017). There is similar layering in the C500 composite, but the graphene particles are more pronounced and dispersed between layers (FIG. 7B). When considering the C750 composites, the structure is much less regularly layered (FIG. 7C). While there appears to be some orientation of the material in a somewhat layered fashion, the C750 composite does not appear to be as ordered as the C300 and C500 composites. Also, the graphene particles are clearly pronounced in the C750 composites and are not evenly dispersed into the chitosan. However, the C750 composites have more order than the CS only membranes in the previous studies. These results indicate that the addition of graphene into chitosan introduces order into the morphology, and that the order of the CSG composite increases as graphene surface area decreases. The thickness of each composite was also determined to be 19.4 μm for CSG C300, 32.2 μm for CSG C500, and 54.2 μm for CSG C750.

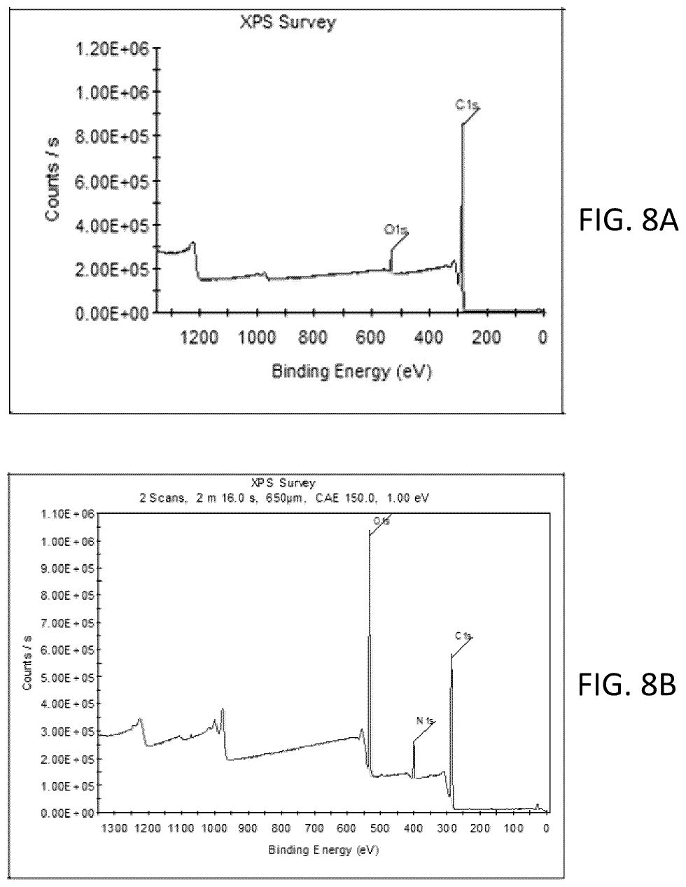

To assess the chemical composition of the graphene materials and chitosan-graphene composites, the samples were characterized by X-ray photoelectron spectroscopy (XPS). Initial survey scans were taken between 0 and 1400 eV binding energy for the three grades of graphene and their respective CSG composite. A representative scan of C750 graphene and CSG 750 composite is shown is FIG. 8A and FIG. 8B, and a summary of the XPS survey results is provided in Table 3. The XPS survey scans showed carbon and oxygen in the graphene samples, and carbon, oxygen, and nitrogen in the chitosan-graphene samples. The elemental composition for graphene is expected as the commercial grade graphene undergoes some oxidation, and the overall oxygen concentration increases as the surface area increases. The C/O ratio for the CSG composites is similar to the ratio for CSGO composites found in previous studies (Abolhassani et al., 2017).

TABLE 3

| Composite | C (at. %) | O (at. %) | N (at. %) | C/O ratio |
|---|---|---|---|---|
| GO¹ | 60.8 | 38.0 | | 2 |
| CS/0¹ | 62.0 | 27.5 | 10.6 | 5 |
| DG-CSGO¹ | 51.9 | 39.7 | 8.1 | 2.2 |
| C300 | 96.74 | 3.26 | | 29.67 |
| C500 | 95.94 | 4.06 | | 23.63 |
| C750 | 94.82 | 5.18 | | 18.31 |
| CSG C300 | 62.87 | 29.67 | 7.03 | 2.12 |
| CSG C500 | 69.76 | 24.01 | 5.77 | 2.91 |
| CSG C750 | 61.67 | 30.82 | 7.51 | 2.00 |

XPS measurements for C grade graphene, CSG composites, graphene oxide (GO), chitosan (CS/0), and chitosan-graphene oxide composite (DG-CSGO).
¹Abolhassani et al. 2017.

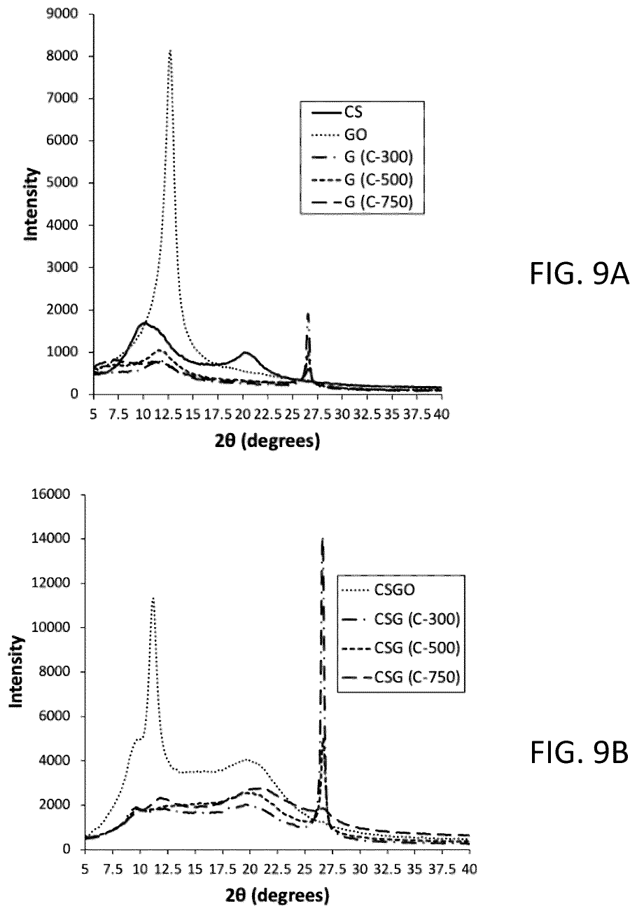

X-ray Diffraction (XRD) was used to evaluate the crystallinity of the starting materials in commercially available powder form and the composites. In FIG. 9A, the two broad peaks for chitosan (CS) at 9.6° and 20.5° indicate amorphous structure of the CS film in agreement with other investigator's XRD studies on pure chitosan (Kumar and Koh, 2012). Graphene oxide (GO) displays a single crystalline peak at 12.7°. The three grades of graphene show similar peaks in the same locations, a broad peak at 11.5° and a “graphite” peak at 26.5°. There is a clear inverse relationship between the diffraction intensity and the surface area of the graphene, suggesting more 3-D “graphite” morphology at C300 trending towards more 2-D graphene morphology at C750. The observed trend with the peak at 26.5° suggests that increased surface area leads to more two-dimensionality and more graphene like structure at the surface. The XRD for these samples can be compared to the PXRD for the composite materials in FIG. 9B.

The PXRD of chitosan graphene oxide (CSGO) composite shows a combination of the two amorphous CS peaks at 9.6° and 20.5° and a crystalline peak at 11.1°. The crystalline peak is shifted left from the peak at 12.7° in the pure GO, indicating that the interlayer spacing is greater in CSGO than the spacing in GO. These results indicate this composite is semicrystalline, which is consistent with other investigators (Abolhassani et al., 2017). When comparing the three CSG composites, crystalline behavior depends greatly on surface area. For all grades of graphene used in CSG, the amorphous CS peak at 9.6° is present, but the 11.5° peak from the pure graphene is only preserved in the C750 grade. The presence of the peak at 11.5° may be a result of the graphene being less integrated into the CS for the C750 grade than for the other grades. Additionally, the amorphous CS peak is shifted slightly right to 21.0°.

The crystalline peak at 26.5° in CSG C750 decreases in intensity when compared to both the pure graphene and the other CSG composites. This indicates that CSG C750 is still semicrystalline but has a larger amorphous fraction than the other composites. The crystallinity results are consistent with the morphology seen in the SEM, with the C750 particles less dispersed and graphene structure more prominent on the surface than the other composite materials. The increased amorphous behavior is also reflected in the increased thickness of the film, as the increased amorphous behavior introduces increased free hole volume for the same amount of material. The trend of increasing crystallinity for decreasing surface area seen in the pure graphene is maintained in the CSG composites. In fact, the composites display a higher intensity crystalline peak than in the pure graphene.

### Example 5

### Algal Density Removal Studies

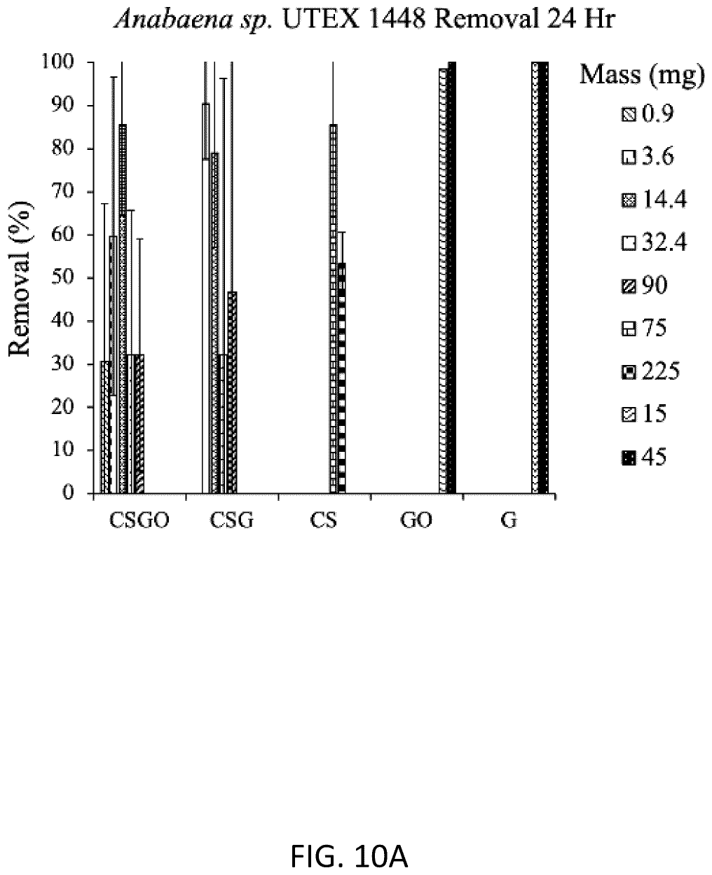

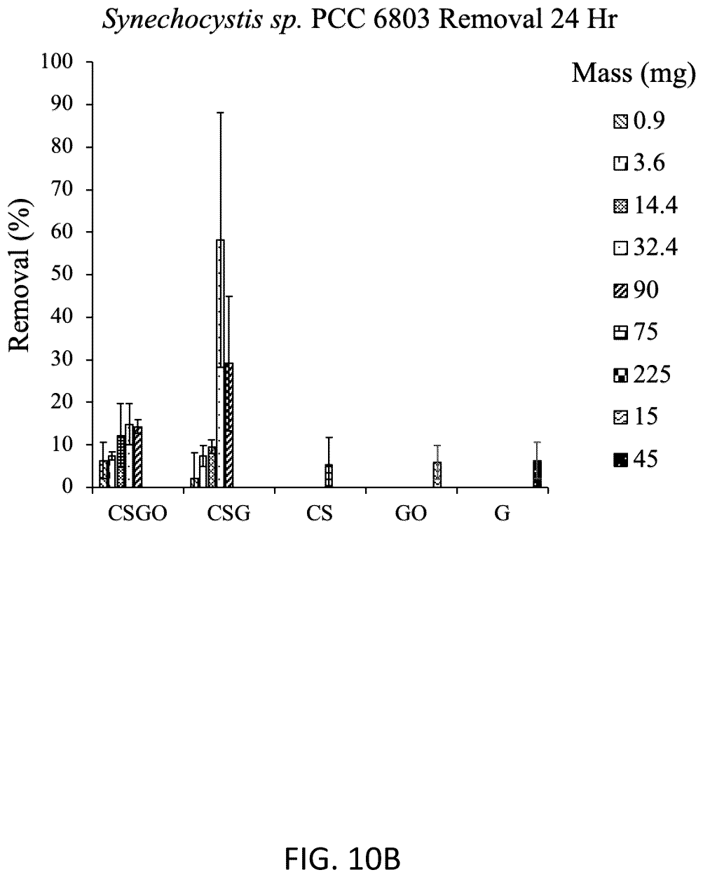

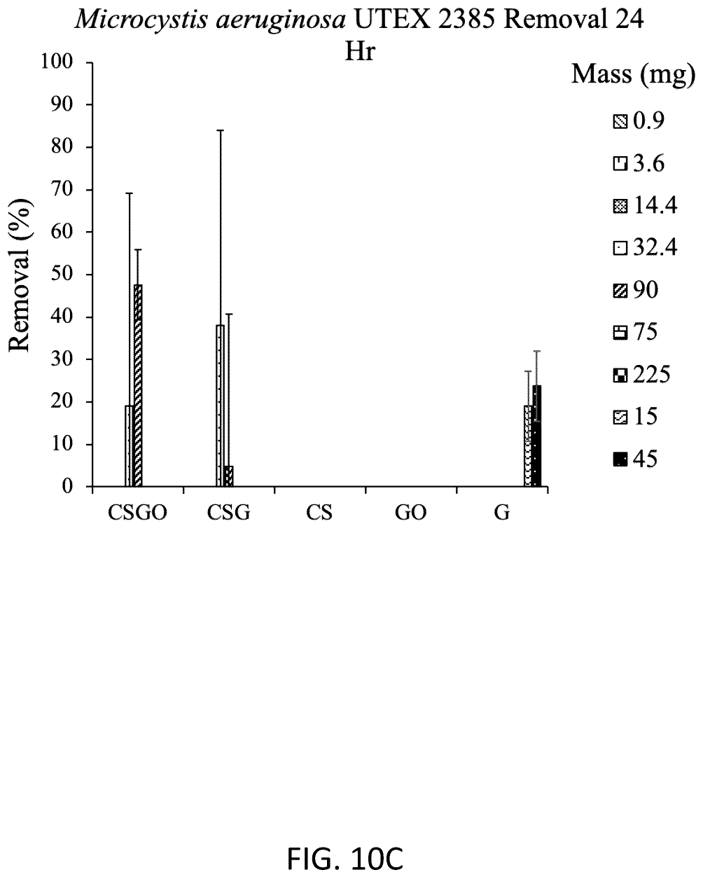

Because the SEM and XRD results displayed more graphene nanoplatelets on the CSG C750 composites as compared to the others (C300 and C500), it was selected to evaluate graphene interactions with algal density and the microcystin MC-LR. The increased amount of surface-bound graphene allows for it to be more readily available in determining the efficacy of graphene in binding algae and MC-LR. The UV-VIS optical density was calculated after 24 h incubation between the composite and graphene materials and the three algae species (FIG. 10A-10C). Removal percentages were calculated relative to a control sample with no added treatment. The results are also tabulated in Table 4.

TABLE 4

| Species | Mass (mg) | CSGO | CSG | CS | GO | G |
|---|---|---|---|---|---|---|
| Anabaena sp. | 0.9 | 30.65 | 0 | | | |
| UTEX 1448 | 3.6 | 59.68 | 90.32 | | | |
| | 14.4 | 85.48 | 79.03 | | | |
| | 32.4 | 32.26 | 32.26 | | | |
| | 90 | 32.26 | 46.77 | | | |
| | 75 | | | 85.48 | | |
| | 225 | | | 53.23 | | |
| | 15 | | | | 98.39 | 100 |
| | 45 | | | | 100 | 100 |
| Microcystin aeruginosa | 0.9 | 52.38 | 0 | | | |
| UTEX 2385 | 3.6 | 0 | 0 | | | |
| | 14.4 | 0 | 0 | | | |
| | 32.4 | 19.05 | 38.10 | | | |
| | 90 | 47.62 | 4.76 | | | |
| | 75 | | | 0 | | |
| | 225 | | | 0 | | |
| | 15 | | | | 0 | 19.05 |
| | 45 | | | | 0 | 23.81 |
| Synechocystis sp. | 0.9 | 0 | 24.79 | | | |
| PCC 6803 | 3.6 | 34.19 | 47.01 | | | |
| | 14.4 | 85.47 | 60.68 | | | |
| | 32.4 | 64.96 | 94.02 | | | |
| | 90 | 46.15 | 73.50 | | | |
| | 75 | | | 0 | | |
| | 225 | | | 0 | | |
| | 15 | | | | 32.48 | 31.62 |
| | 45 | | | | 12.82 | 10.26 |

Within 24 hours, CSG composite material, G, and GO were able to remove at least 90% Anabaena sp., with G removing 100% (FIG. 10A). Comparing the composites to the G and GO powder, the powders were able to produce a slightly higher removal rate. The high removal rate for the CSG composite material demonstrates that the G functionality was successfully transferred to the composite material.

Synechocystis sp. removal showed both CSG and CSGO composites were able to achieve approximately 90% or greater removal (FIG. 10B). Chitosan showed no removal. Comparing the composites to the loose G and GO, the composites performed better than the loose material. This result indicates that while the effectiveness of the composite comes from the graphene, this algal strain needs the composite for effective removal treatment.

The removal results for Microcystis aeruginosa show that the materials had inconclusive removal (FIG. 10C). The chitosan by itself showed no removal, so the removal seen in the composites is a result of the graphene. The CSGO and CSG composites performed the best, with the CSG able to remove about 40%. The overall effectiveness of the composite materials was based on the amount used, but no definitive trend is observed. The highest removal at 24 hours was achieved at almost 50% removal for the high mass CSGO composite. Overall, these results demonstrate that algal removal is species dependent.

### Example 6

### Algae Toxin Removal

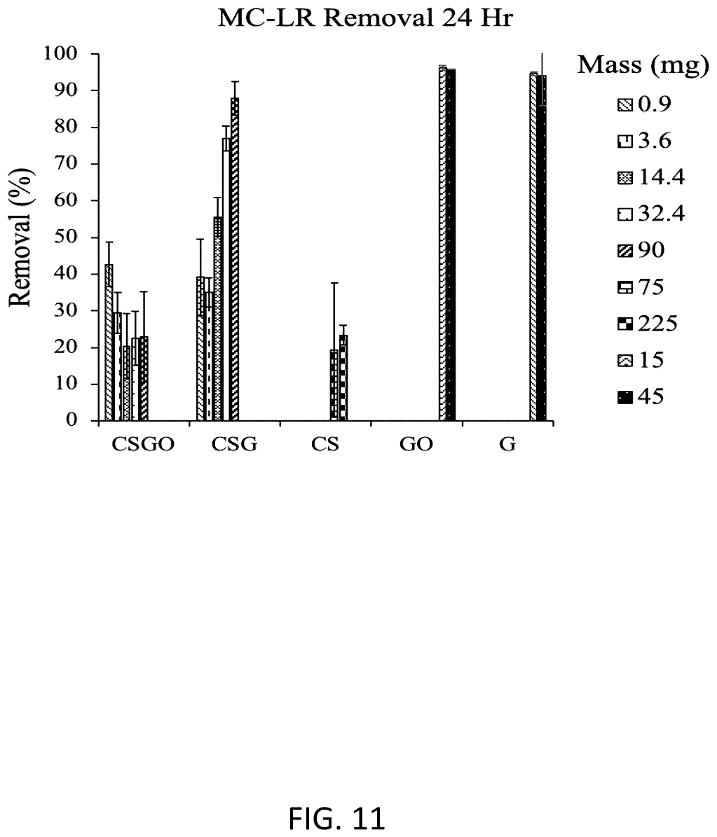

M. aeruginosa is a microcystin producing strain and samples were tested for the removal of MC-LR. The efficacy of CSGO and CSG composites and the CS, GO and G materials was evaluated by measuring the MC-LR concentration by ELISA before and after 24 h exposure to the materials (FIG. 11). The results are also tabulated in Table 5.

TABLE 5

| | CSGO | CSG | CS | GO | G |
|---|---|---|---|---|---|
| | Re- | Re- | Re- | Re- | Re- |
| Mass (mg) | moval % | moval % | moval % | moval % | moval % |
| 0.9 | 42.6 | 39.1 | | | |
| 3.6 | 29.4 | 35.0 | | | |
| 14.4 | 20.4 | 55.6 | | | |
| 32.4 | 22.5 | 77.0 | | | |
| 90 | 22.9 | 87.9 | | | |
| 75 | | | 19.4 | | |
| 225 | | | 23.4 | | |
| 15 | | | | 96.2 | 94.6 |
| 45 | | | | 95.8 | 94.1 |

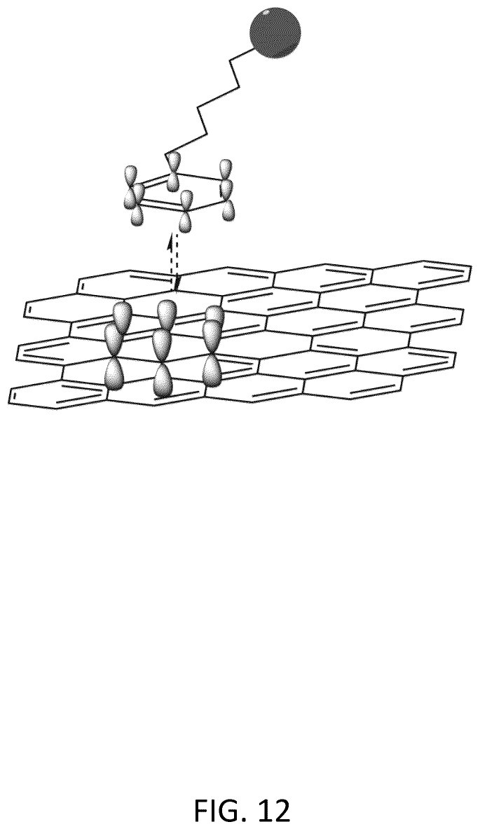

Results show that G and GO oxide are effective at microcystin removal. CS alone was ineffective at removing microcystin, while G and GO were able to remove approximately 95% of the MC-LR. When comparing the two composites, CSG is significantly more effective than CSGO. Without being bound to any one theory, this demonstrates that the functionality of the graphene is a result of the 7C-7C interactions with the aromatic backbone of MC rather than any functionality of the oxygen groups (FIG. 12). The effectiveness of the CSG composite increased with increasing mass of composite, while CSGO composites showed the opposite trend.

When comparing the effectiveness of the CSG and CSGO composites to the G and GO loose powder, the powder may be slightly more effective than the composites. Composites weighing 90 mg have 15 mg of graphene, so a direct comparison shows that the effectiveness of the GO was not transferred to the CSGO composite. Since CSG and G are more similar in performance, the G functionality is successfully transferred to the composite. The CSG composite is effective as a result of the graphene and does not lose effectiveness to the chitosan. Without being bound to any one theory, the mechanism for removal is hydrophobic π-π interactions achieving more than 95% removal of MC-LR for graphene materials. This toxin removal is achieved even without optimal removal of the algal cells, mitigating a major threat posed by HABs.

### Example 7

### MC-LR Adsorption Kinetics

To further explore the mechanism of interaction and removal capacities of graphene materials with MC-LR, adsorption kinetics and isotherm studies were conducted using water spiked with known initial MC-LR concentrations. The kinetic studies were run at an environmentally relevant MC-LR concentration of 8 μg/L at neutral pH 7.4 with 50 mg of powdered graphene and graphene oxide, and 50 mg cutouts of the CSGO and CSG composites. Chitosan was not effective at removing MC-LR from the previous study, therefore it was emitted for the kinetic and isotherm experiments.

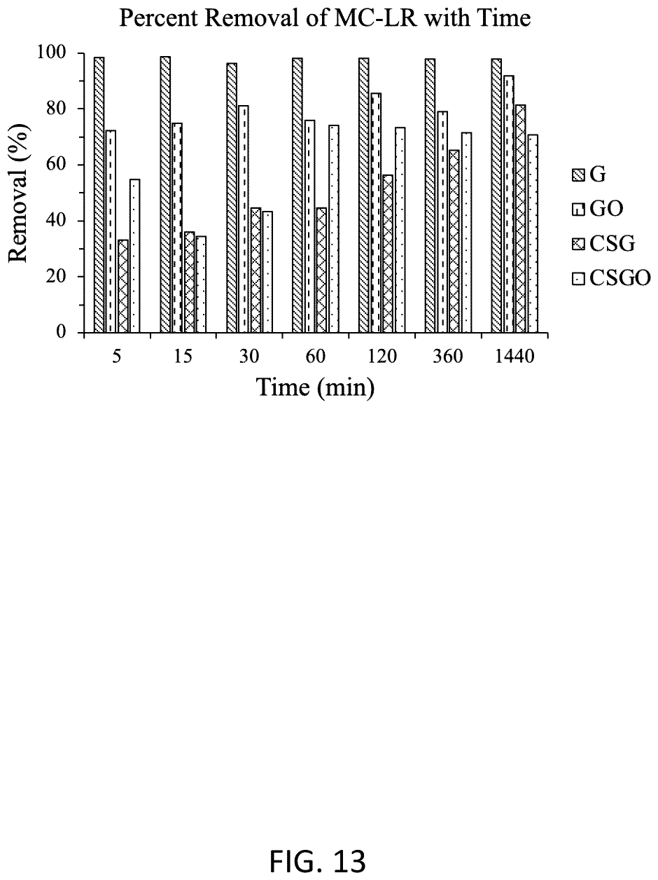

Samples were taken at various time points (0, 1, 5, 15, 30, 60, 120, 360, and 1440 minutes) and the concentration of MC-LR was measured using ELISA microarray (FIG. 13). The MC-LR adsorption occurred rapidly in the first 5 minutes for the G and GO samples, with a removal rate of 98.3% for G and 72.3% for GO. The GO eventually reached 91.9% removal after 24 hours. In comparison, the CSG and CSGO composites only removed 41.5% and 33.1% after 5 minutes, and 81.5% and 70.7% after 24 hours, respectively. These removal percentages support the previous findings with MC-LR from M. aeruginosa in that MC-LR removal is dependent on the presence of graphene and that G is more powerful than GO. The kinetic study provides more evidence that the π-π interactions between graphene and the aromatic group on the ADDA chain of MC-LR are the driving factor in the exceptional adsorption behavior.

### SUMMARY

Various embodiments of chitosan graphene composites were successfully fabricated and characterized using SEM, XPS, and XRD. The grade of graphene used in the CSG composite affects the properties of the composite. The SEM imaging and the XRD show that embodiments of the CSG composites have different structures based on the grade of graphene. The lowest surface area graphene is the most ordered and crystalline, while the higher surface area graphene is less ordered and more amorphous. Because the properties of the CSG composites can be changed depending on the graphene grade used, the properties of various embodiments of the CSG composites can be tuned to fit the desired application.

Various embodiments of the chitosan graphene-based materials are effective for management of microorganisms and toxins produced by harmful algal blooms. The disclosed studies achieved about 90% density reduction for two of the three algae types for at least one embodiment of the graphene-based material, with 100% removal reached in two of the three algal species. For M. aeruginosa that produces the cyanotoxin MC-LR, various embodiments of graphene, graphene oxide, and chitosan graphene were able to remove about 87-96% of the toxin present within 24 hours. Kinetic studies with various embodiments of graphene and chitosan graphene composite matrices displayed quick removal MC-LR from spiked water and indicate high removal capacities. In various embodiments of chitosan graphene-based materials, π-π interactions between graphene and MC-LR are a dominating force for removal. Overall, these studies successfully prove that chitosan graphene technologies can make water bodies affected by HABs safe for wildlife and secure for human use.

It is to be understood that where the claims or specification refer to “a” or “an” element, such reference is not to be construed that there is only one of the element. If the specification or claims refer to “an additional” element, that does not preclude there being more than one of the additional element.

It is to be understood that where reference is made herein to a method or process that includes two or more defined steps, the defined steps can be carried out in any order or simultaneously (except where context excludes that possibility), and the process can also include one or more other steps which are carried out before any of the defined steps, between two of the defined steps, or after all of the defined steps (except where context excludes that possibility). Methods of the disclosure may be implemented by performing or completing manually, automatically, or a combination thereof, selected steps or tasks.

For purposes of the disclosure, the term “at least” followed by a number is used herein to denote the start of a range beginning with that number (which may be a range having an upper limit or no upper limit, depending on the variable being defined). For example, “at least 1” means 1 or more than 1. Terms of approximation, such as “about,” should be interpreted according to their ordinary and customary meanings as used in the associated art unless indicated otherwise. Absent a specific definition and absent ordinary and customary usage in the associated art, such terms should be interpreted to be ±10% of the base value.

When a range is given as “(a first number) to (a second number)” or “(a first number)-(a second number)” this means a range whose lower limit is the first number and whose upper limit is the second number. For example, 25 to 100 or 25-100 should be interpreted to mean a range whose lower limit is 25 and whose upper limit is 100. Additionally, it should be noted that where a range is given, every possible subrange or interval within that range is also specifically intended unless the context indicates to the contrary. For example, if the specification indicates a range of 25 to 100 such range is also intended to include subranges such as 26-100, 27-100, etc., 25-99, 25-98, etc., as well as any other possible combination of lower and upper values within the stated range, e.g., 33-47, 60-97, 41-45, 28-96, etc. Note that integer range values have been used in this paragraph for purposes of illustration only and decimal and fractional values (e.g., 46.7-91.3) should also be understood to be intended as possible subrange endpoints unless specifically excluded.

While inventive concepts have been described and illustrated herein by reference to certain embodiments, various changes and further modifications may be made by those of ordinary skill in the art without departing from the spirit of the inventive concept, the scope of which is to be determined by the following claims.

What is claimed is:

1. A chitosan-graphene composite material, comprising:
chitosan polymer substrate; and
graphene.

2. The chitosan-graphene composite material of claim 1, wherein the chitosan has a molecular weight in a range of about 190,000-310,000 g/mol.

3. The chitosan-graphene composite material of claim 1, wherein the chitosan has a deacetylation degree of at least 75%.

4. The chitosan-graphene composite material of claim 1, wherein the graphene comprises nanoplatelets having a particle surface area in a range of about 300-750 m²/g.

5. The chitosan-graphene composite material of claim 4, wherein the nanoplatelets have a particle size of about 2 μm.

6. The chitosan-graphene composite material of claim 1, comprising about 15-18% by weight graphene and about 82-85% by weight chitosan.

7. The chitosan-graphene composite material of claim 1, wherein a ratio of the chitosan to the graphene is in a range of about 5:1 to about 4:1 w/w.

8. The chitosan-graphene composite material of claim 1, wherein the material has an area density in a range of about 0.040 mg/mm² to about 0.080 mg/mm².

9. The chitosan-graphene composite material of claim 1, wherein the material has a thickness in a range of about 15 μm to about 75 μm.

10. The chitosan-graphene composite material of claim 1, wherein the material is a flat sheet.

11. The chitosan-graphene composite material of claim 1, wherein the material is a scalable chitosan-graphene composite material.

12. A method of making a chitosan-graphene composite material, the method comprising:
providing a quantity of graphene;
providing a quantity of chitosan;
combining the chitosan and the graphene to create a chitosan-graphene solution;
casting the chitosan-graphene solution to a desired structure; and
curing the chitosan-graphene solution.

13. The method of claim 12, wherein the graphene is provided in an aqueous solution.

14. The method of claim 13, wherein the graphene is sonicated in the aqueous solution to create a graphene dispersion.

15. The method of claim 12, wherein the chitosan and the graphene are combined in an acidic solution.

16. The method of claim 15, wherein the acidic solution comprises an organic acid.

17. The method of claim 16, wherein the acidic solution comprises an acid selected from the group consisting of acetic acid, malic acid, succinic acid, glycolic acid, oxalic acid, adipic acid, citric acid, formic acid, carboxylic acid, sulfonic acid, muriatic acid, tannic acid, and a combination thereof.

18. The method of claim 12, wherein curing the chitosan-graphene solution comprises evaporating the solution.

19. The method of claim 12, wherein the method is scalable.

20. The method of claim 12, wherein the chitosan-graphene composite material is a flat sheet.

21. The method of claim 12, wherein the chitosan-graphene composite material comprises up to about 15-18% by weight graphene and about 82-85% by weight chitosan.

22. The method of claim 12, wherein a ratio of the chitosan to the graphene is in a range of about 5:1 to about 4:1 w/w.

23. The method of claim 12, wherein the chitosan-graphene solution is cast to create a total surface area in a range of about 180-220 cm 2 per 100 mL of solution.

24. The method of claim 12, wherein the graphene comprises nanoplatelets having a particle surface area in a range of about 300-750 m²/g.

25. A method of removing microorganisms from water, the method comprising bringing the water into contact with the chitosan-graphene composite material of claim 1.

26. The method of claim 25, wherein the water is contaminated by a harmful algal bloom.

27. The method of claim 25, wherein the microorganism is one or more cyanobacteria or blue-green algae.

28. A method of removing algal toxin from toxin-contaminated water, the method comprising bringing the water into contact with the chitosan-graphene composite material of claim 1.

29. The method of claim 28, wherein the algal toxin is contained in water contaminated by a harmful algal bloom.

30. The method of claim 28, wherein the algal toxin is microcystin.
